(19) United States
(12) Patent Application Publication
(10) Pub. No.: US 2009/0094263 A1
(43) Pub. Date: Apr. 9, 2009

(54) ENHANCED UTILIZATION OF NETWORK BANDWIDTH FOR TRANSMISSION OF STRUCTURED DATA

(75) Inventors: Tomer Shiran, Haifa (IL); Nir Nice, Kfar Vradim (IL); Itai Almog, Redmond, WA (US); Adar Greenshpon, Haifa (IL)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 11/867,100

(22) Filed: Oct. 4, 2007

(51) Int. Cl. G06F 17/30

(52) U.S. Cl. 707/101; 707/E17.005

(57) ABSTRACT

Systems and methods are described that improve the efficiency of byte caching mechanisms when transmitting or receiving structured data. Some of these techniques may normalize the structured data before transmission over the network. Other techniques may use templates or semantic differences.

### BACKGROUND

Currently, many users interact with network-enabled applications. A user on his home computer, for instance, may interact with a web browser application to view web pages over the Internet. Other users may use a remote desktop application to access a remote computer while traveling or telecommuting. As a result networks (e.g., local area networks (LANs); wide area networks (WANs) and the Internet) are carrying an increasing volume of data. Similarly, Internet sites that receive a lot of traffic (e.g., MSN.com; CNN.com; or FoxNews.com) are constantly sending the same web page or data over the Internet. While the end destination is often different, duplicate data is often sent over portions of the network. The transmission of duplicate data contributes to network congestion, a reduction in the available bandwidth, and slower network response.

One well-known method of reducing the amount of traffic between two endpoints is the use of sequence caching. According to this method, when endpoint A sends a sequence of data to endpoint B, it identifies subsequences of data that were previously sent and replaces them with compact identifiers. Upon receiving a data sequence consisting of such identifiers (aka placeholders) from endpoint A (the sending endpoint), endpoint B (the receiving endpoint) replaces the identifiers with the original subsequences, thereby restoring the actual sequence of data. This mechanism, sometimes called “byte caching” or “TCP caching,” reduces the amount of traffic that is transmitted over a link.

This mechanism is beneficial when large sequences of data are repetitively transmitted over a network link. However, this mechanism does not work as well for protocols that consist of structured data where equality is defined by a condition other than straightforward binary equality. For example, according to the semantics of XML, the following sequences may be equivalent:

<car color=red make=1999><engine size=1800/></car>

<car make=“1999” color=“red”><engine size=“1800”></engine></car>

When using prior art mechanisms, the preceding sequences do not have any significant repetitive data. However, they are semantically equivalent and therefore a smarter mechanism (as proposed in this patent) can refrain from sending such sequences over a slow link multiple times.

### SUMMARY

Systems and/or methods (“tools”) are described that enable Internet nodes to enhance or improve the use of network bandwidth when transmitting data.

In one implementation, a transmitting or sending network node automatically normalizes or reformats the structured data (e.g., HTML or XML) prior to sending the data over the network. Thus, the structured data would be read, the data placed in a standard or predetermined format, and then the normalized or reformatted structured data would be transmitted. By transmitting this normalized or reformatted structured data, standard byte caching mechanisms can be effectively used for structured data.

For example, in some embodiments, normalizing or reformatting may remove redundant white space or use white space in a consistent manner. Thus, differences in white space which did not impact or change the semantics of the structured data would be eliminated.

In other embodiments, the normalizing or reformatting uses quotation marks consistently throughout the structured data. Thus, differences in the type, presence, or absence of quotation marks which did not impact or change the semantics of the structured data would be eliminated.

In further embodiments, the normalizing or reformatting orders element attributes consistently throughout the structured data. Thus, differences in the order of attributes which did not impact or change the semantics of the structured data would be eliminated.

In another implementation, the transmitting or sending network node automatically converts or replaces the structured data with a pre-determined or pre-negotiated template prior to sending the data over the network. Thus, the structured data would be read, a template selected, the data required to fill in the template identified and then a template ID and the identified data to fill in the template would be transmitted. By replacing structured data with a template ID and the data to fill in the template, less data is transmitted. Thus, the available network bandwidth would be efficiently used.

In a further implementation, the transmitting or sending node replaces the structured data with a difference message. The transmitting or sending node calculates or determines the semantic difference between a first message or sequence of data and a second message or sequence of data. Thereafter, the transmitting or sending node sends the structured difference in a message. Since the message uses less bandwidth than the structured data, the network's available bandwidth is used efficiently.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIG. 1 illustrates an exemplary operating environment in which various embodiments can operate.

FIG. 2 is an exemplary process for normalizing structured data.

FIG. 3 illustrates a second exemplary process for normalizing structured data.

FIG. 4 is an exemplary process for using templates to transmit structured data.

FIG. 5 illustrates an exemplary process for using templates to receive structured data.

FIG. 6 is an exemplary process for using semantic differences to transmit structured data.

FIG. 7 is an exemplary process for using semantic differences to receive structured data.

FIG. 8 is an example of normalizing structured data prior to transmission.

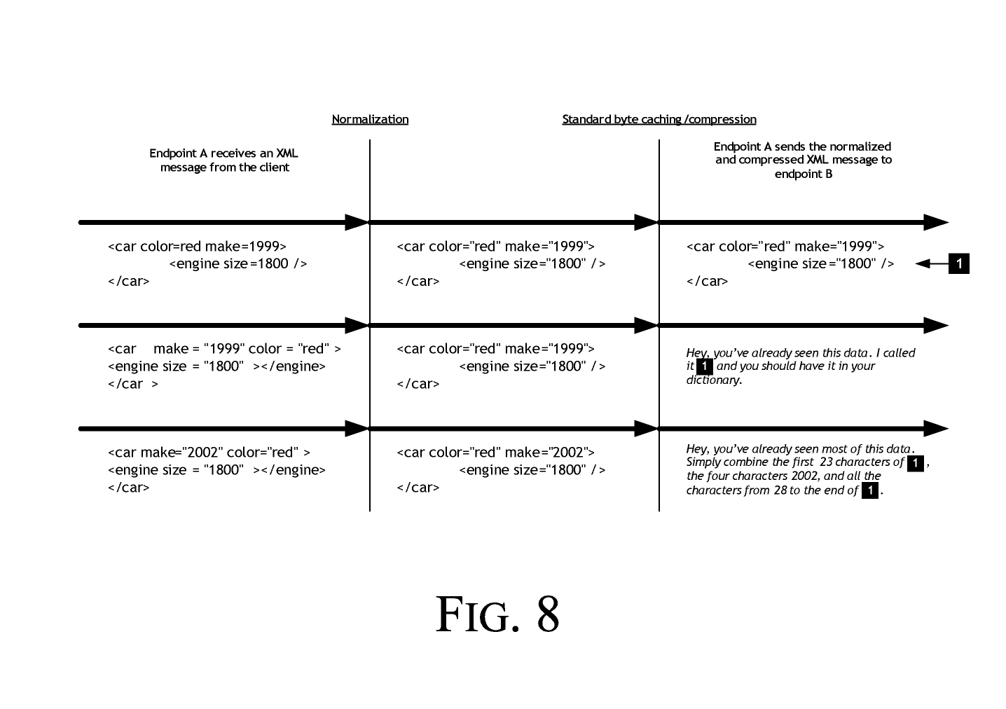

FIG. 9 is an example of using a template to transmit structured data.

FIG. 10 is an example of a process that may be used in FIG. 4.

The same numbers are used throughout the disclosure and figures to reference like components and features.

### DETAILED DESCRIPTION

### Overview

The following document describes systems and methods (“tools”) capable of many powerful techniques, which enable, in some embodiments: structured data to be transmitted with a consistent internal format to take advantage of byte caching, structured data to be transmitted using template identifiers, and structured data to be transmitted as an initial data sequence followed by semantic differences that can be used to reconstruct the data sequences represented by the semantic differences.

An environment in which these tools may enable these and other techniques is set forth below. This is followed by other sections describing various inventive techniques and exemplary embodiments of the tools.

### Exemplary Operating Environment

Before describing the tools in detail, the following discussion of an exemplary operating environment is provided to assist the reader in understanding one way in which various inventive aspects of the tools may be employed. The environment described below constitutes but one example and is not intended to limit application of the tools to any one particular operating environment. Other environments may be used without departing from the spirit and scope of the claimed subject matter.

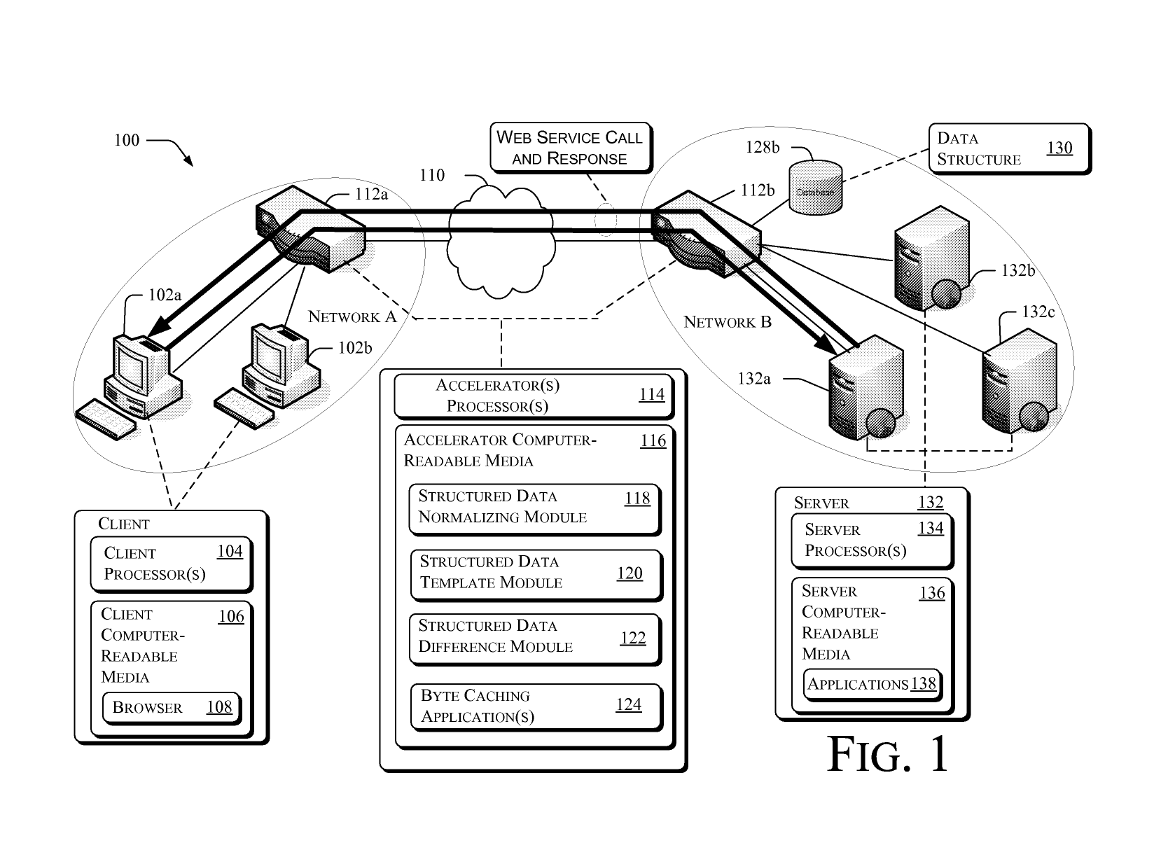

FIG. 1 illustrates one such operating environment generally at 100 that may include local network A and local network B interconnected with network 110. The network 110 enables communication between networks A and B, and can comprise a global or local wired or wireless network, such as the Internet or a company's intranet. Typically Networks A and B are interconnected with network 110 via accelerators 112a and 12b.

Network A may have one of more clients 102a and 102b. Each client 102 having one or more client processors 104 and client computer-readable media 106. The client 102 comprises a computing device, such as a cell phone, desktop computer, personal digital assistant, or server. The processors 104 are capable of accessing and/or executing the computer-readable media 106. The computer-readable media 106 comprises or has access to a browser 108, which is a module, program, application or other entity capable of interacting with a network-enabled entity. Network A may also include accelerator 112a.

Network B may have one of more servers 132a, 132b and 132c. Each server 132 has one or more server processors 134 and server computer-readable media 136. The server 132 may comprise a web server, an application server, an email server, or other server. The processors 134 are capable of accessing and/or executing the computer-readable media 136. The computer-readable media 136 comprises or has access to one or more application(s) 138, which may be modules, programs, applications or other entities capable of interacting with a network-enabled entity. Network B may also include accelerator 112a.

Accelerator112 may comprise any device that is used to accelerate the movement of information across a network. Examples of accelerators include but are not limited to proxy servers, WAN accelerators, network accelerators, which could be independent devices or part of firewalls or routers.

Each accelerator112 may comprise accelerator processor(s) 114 and accelerator computer-readable media 116. The accelerator processor(s) 114 are capable of accessing and/or executing the accelerator computer-readable media 116. The accelerator computer-readable media 116 comprises or has access to one of a structured data normalizing module 118, a structured data template module 120, and a structured data difference module 122. The details of examples of each of these modules are discussed below.

The accelerator computer-readable media 116 may also comprise a byte caching application(s) 124. The accelerator(s) 112 in FIG. 1 are shown with all of these elements for the sake of illustration, though one or more of these elements may be spread over individual servers or other entities comprised by accelerator(s) 112, such as another computing device that acts to govern the accelerators 112a, 112b, and 112c.

The operating environment 100 may also comprises database(s) 128 having a data structure 130. In some embodiments the accelerator 112 is capable of communicating with one of more of the databases 128 to access or store available templates if the structured data template module is used.

### Normalizing Structured Data

The following discussion describes exemplary ways in which the tools normalize structured data prior to transmission to permit efficient use of byte caching tools or applications. This discussion also describes ways in which the tools perform other inventive techniques as well.

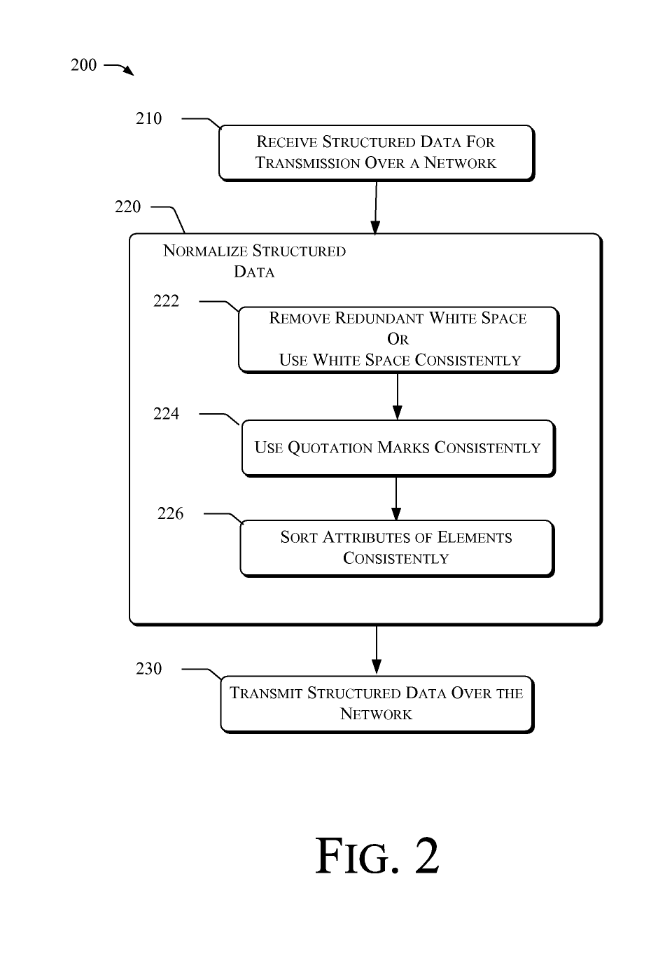

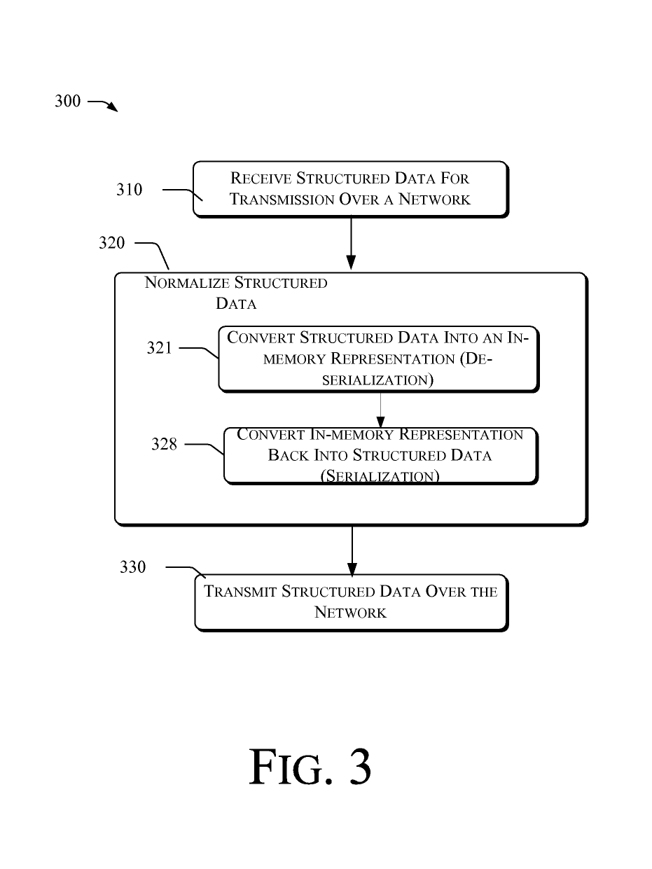

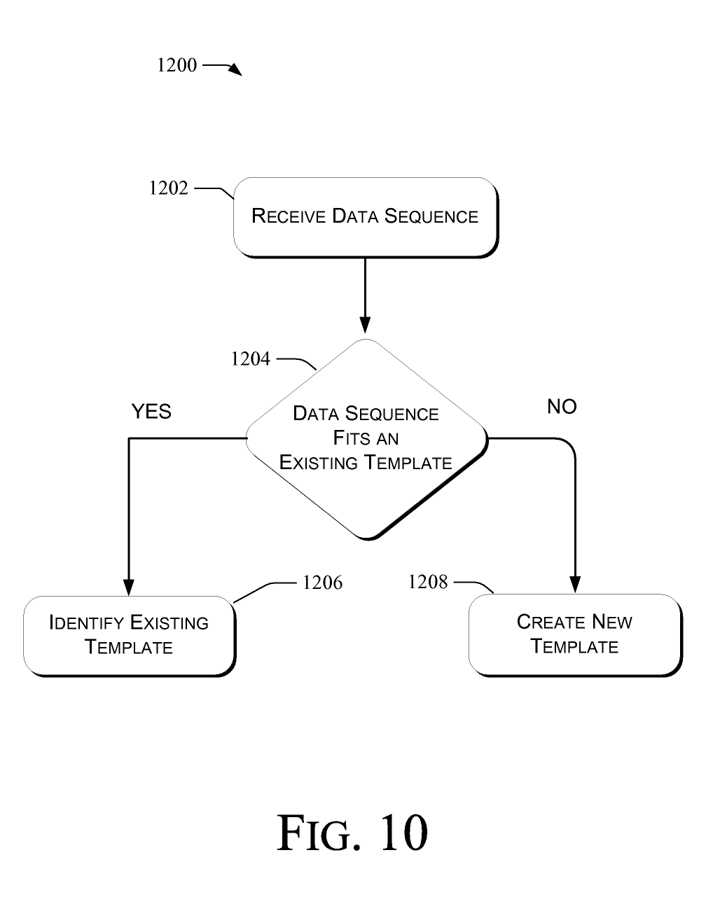

FIGS. 2 and 3 illustrate two examples of methods that may be used to normalize structured data. FIG. 10 (described below) provides an example of normalized structured data. The normalized data may then take advantage of existing byte caching mechanisms. The normalization might include one or more of the following techniques: removing all redundant whitespace; using consistent quotation characters; or sorting attributes of a single element (e.g., alphabetically).

The process 200 shown in FIG. 2 is illustrated as a series of blocks representing individual operations or acts performed by elements of operating environment 100 of FIG. 1, such as structured data normalizing module 118. This and other processes disclosed herein may be implemented in any suitable hardware, software, firmware, or combination thereof. In the case of software and firmware, these processes represent a set of operations implemented as computer-executable instructions stored in computer-readable media and executable by one or more processors.

Block 210 receives structured data for transmission over a network. This structured data may originate at the client 102, a web server, or another node on the network. The structured data is normalized in block 220. This normalization places the structured data in a consistent format so that structured data with the same semantic meaning but different binary coding would have the same binary coding. As a result of normalization, the normalized structured data could effectively use byte caching or TCP caching to reduce the bandwidth required to send the structured data. After the structured data is normalized in block 220, the normalized structured data is transmitted over the network in block 230.

In the exemplary embodiment illustrated in FIG. 2, the structured data is normalized (at block 220) by at least one of: removing redundant white space or alternatively, using white space consistently as shown in block 222; using quotation marks consistently as shown in block 224; and sorting attributes of elements within the structured data consistently as provided by block 226.

The process 300 shown in FIG. 3 is illustrated as a series of blocks representing individual operations or acts performed by elements of operating environment 100 of FIG. 1, such as structured data normalizing module 118.

Block 310 receives structured data for transmission over a network. This structured data may originate at the client 102, a web server, or another node on the network. The structured data is normalized in block 320. This normalization places the structured data in a consistent format so that structured data with the same semantic meaning but different binary coding would have the same binary coding. As a result of normalization (block 320), the normalized structured data could effectively use byte caching or TCP caching to reduce the bandwidth required to send the structured data. After the structured data is normalized in block 320, the normalized structured data is transmitted over the network in block 330.

In the exemplary embodiment illustrated in FIG. 3, the structured data is normalized by first converting the structured data into an in-memory representation or de-serialization as shown in block 321 (Also know as an object model). Thereafter, the in-memory representation is converted back into structured data as shown in block 328.

### Using Templates

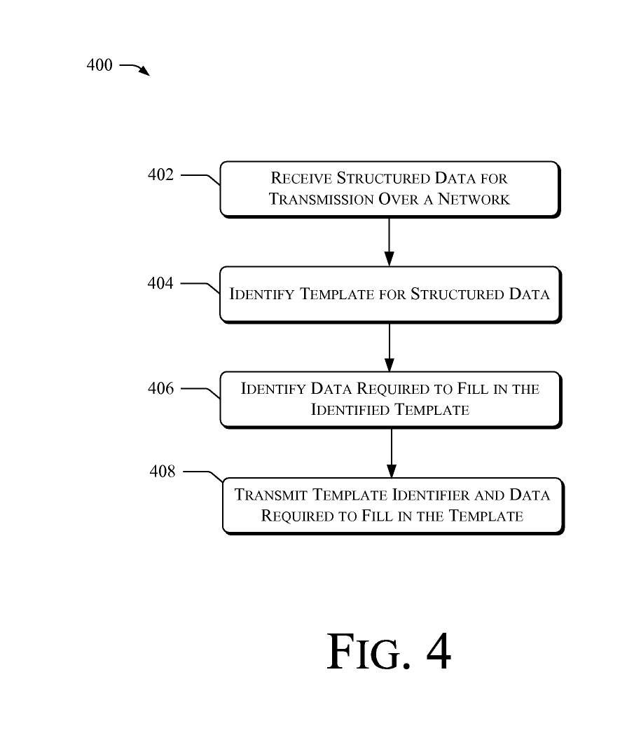

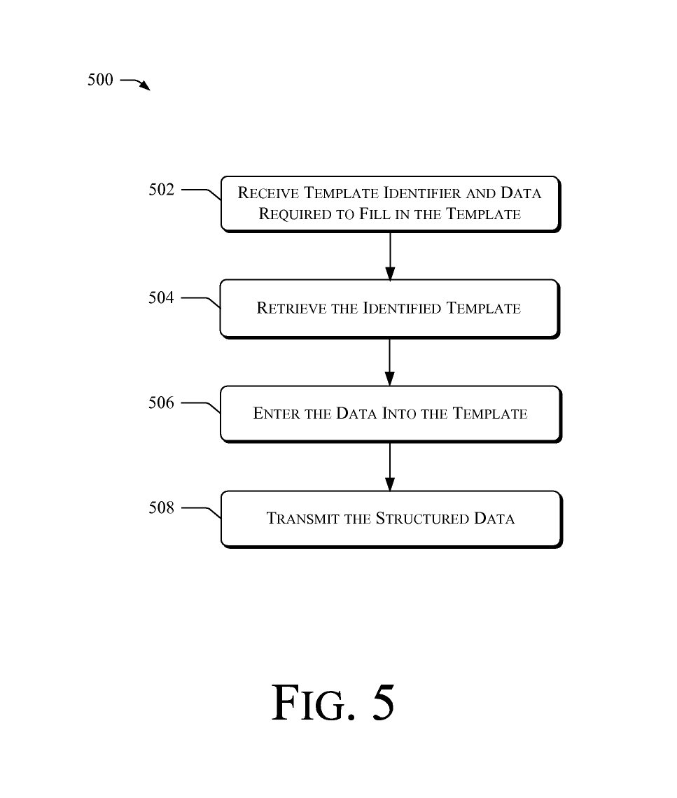

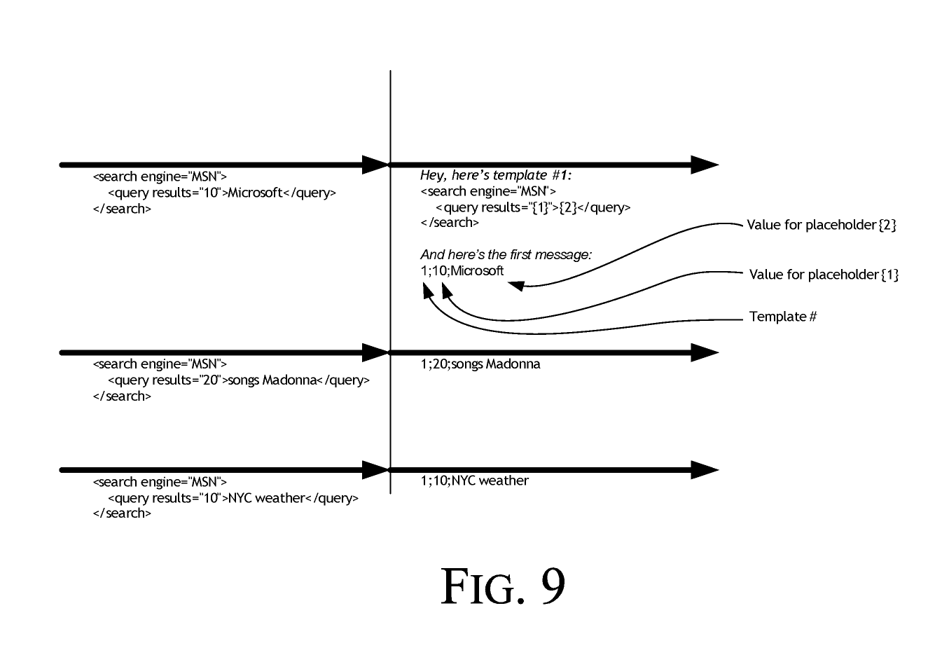

FIGS. 4 and 5 illustrate a further embodiment that uses templates to transmit and receive structured data. FIG. 9 (described below) provides an example of transmitting structured data using a template.

By identifying and caching templates, rather than caching byte sequences, the sending and receiving endpoints can cache the templates and then the sending endpoint transmits only the template ID and data necessary to “fill in” the template. This is an alternative approach for Web services to the normalization discussed above. However, in some embodiments, normalization may be combined with using templates. In a typical scenario, a single Web service is called thousands or millions of times, with slightly different parameters each time. Instead of sending the entire Web service (SOAP) request each time, only the parameters (data required to fill in the template) along with an identifier of the “template” would be sent.

The process 400 shown in FIG. 4 is illustrated as a series of blocks representing individual operations or acts performed by elements of operating environment 100 of FIG. 1, such as structured data template module 120.

In block 402 the structured data that is to be transmitted over a network is received. Based on the content, structure, or other characteristics of the data, a template is identified for the structured data in block 404. Thereafter, the data required to fill in the identified template is determined or identified in block 406. The structured data can be transmitted over the network by sending an identifier for the template and the data required to file in the template in block 408.

FIG. 10 illustrates an exemplary process that may be used in block 404 of FIG. 4. After receiving the structured data (data sequence) in block 1202, the structured data is checked to see if the data sequence fits an existing template in block 1204. When the structured data fits an existing template the process moves to block 1206, where the existing template is identified. If the structured data does not fit an existing template the process moves to block 1208, where a new template is created. Thereafter the process may return to block 406 described above.

FIG. 5 illustrates an exemplary process that may be used to recover the structured data transmitted using the template identifier and data required to file in the template. The process 500 shown in FIG. 5 is illustrated as a series of blocks representing individual operations or acts performed by elements of operating environment 100 of FIG. 1, such as structured data template module 120.

In block 502 the template identifier and the data required to fill in the template are received. Next, the template corresponding to the template identifier is retrieved at block 504. The template may be retrieved from a local data base or other data storage structure. In some embodiments, the template may be stored as a file in a memory.

The data transmitted with the template identifier is entered into the retrieved template in block 506. Thus, the structured data is reconstituted in block 506. Then in block 508 the structured data may be transmitted or forwarded for display or further processing.

### Using Semantic Differences

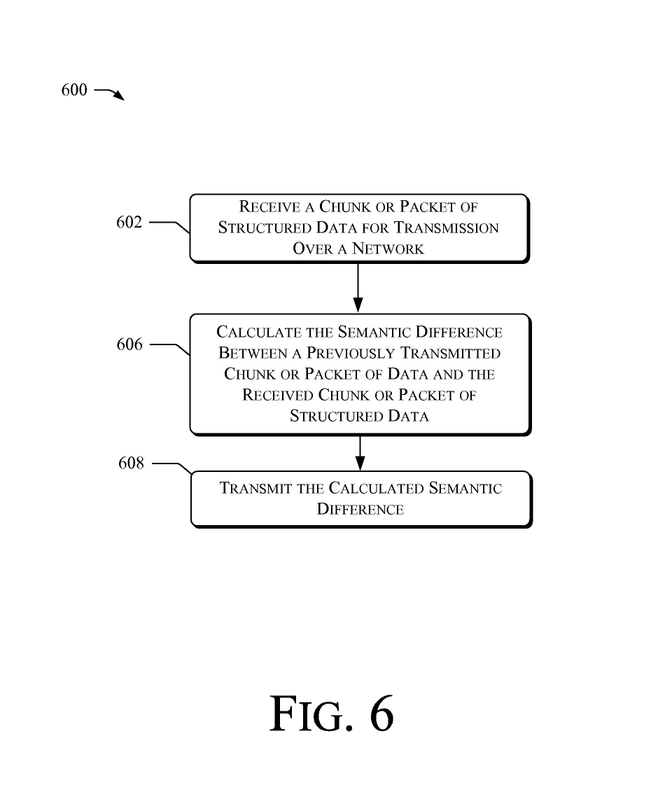

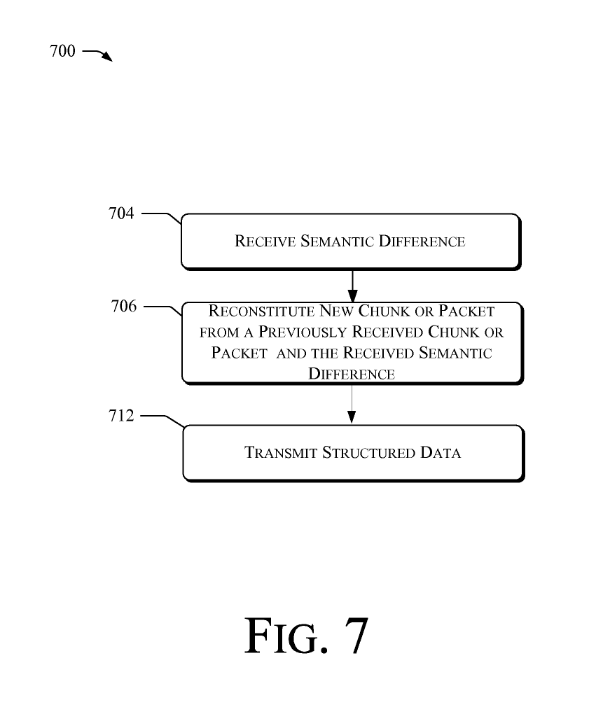

FIGS. 6 and 7 illustrate exemplary processes that may be used to transmit and receive structured data using semantic differences. There are many well-know algorithms for calculating semantic differences between two sequences of data. For example, there are algorithms that can calculate the difference between two XML snippets, ignoring irrelevant differences such as whitespace and attribute order. An example of a Microsoft tool that calculates such differences may be found at http://apps.gotdotnet.com/xmltools/xmldiff/.

The process 600 shown in FIG. 6 is illustrated as a series of blocks representing individual operations or acts performed by elements of operating environment 100 of FIG. 1, such as structured data difference module 122.

In block 602, a segment, chunk or packet of structured data is received for transmission over a network. The semantic difference between a previously transmitted segment, chunk or packet of structured data and the received segment, chunk or packet of structured data to be transmitted is calculated in block 606. Thereafter, this semantic difference is transmitted in block 608.

FIG. 7 illustrates an exemplary process 700 that may be used to recover the structured data transmitted using process 600. The process 700 shown in FIG. 7 is illustrated as a series of blocks representing individual operations or acts performed by elements of operating environment 100 of FIG. 1, such as structured data difference module 122.

In block 704 the semantic difference is received. Thereafter, the data sequence is reconstituted using the previously received segment, chunk or packet of structured data and the received semantic difference in block 706.

Thereafter, in block 712, the reconstituted segment, chunk or packet of structured data is transmitted or forwarded.

### CONCLUSION

The above-described systems and methods enable improved data transmission efficiencies by normalizing structured data, using templates, or transmitting differences. These and other techniques described herein may provide significant improvements over the current state of the art, potentially providing greater usability of server and server systems, reduced bandwidth costs, and an improved client experience with network-enabled applications. Although the system and method has been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

1. A method of transmitting data comprising:
receiving structured data for transmission over a network;
normalizing the received structured data; and
transmitting the normalized structured data.

2. The method of claim 1, wherein normalizing the structured data comprises:
at least one of removing redundant white space or using white space consistently.

3. The method of claim 2, wherein normalizing the structured data further comprises:
using quotation marks consistently.

4. The method of claim 3, wherein normalizing the structured data further comprises:
sorting attributes of elements consistently.

5. The method of claim 1, wherein normalizing the structured data comprises:
converting the structured data into an in-memory representation; and
converting the in-memory representation of the structured data into normalized structured data.

6. The method of claim 1, wherein the structured data is XML or HTML data.

7. A system for transmitting data comprising:
a processor; and
a structured data normalizing module that normalizes structured data before the structured data is transmitted over a network.

8. The system of claim 7, wherein the normalized structured data has redundant white space removed or uses white space consistently.

9. The system of claim 7, wherein the normalized structured data uses quotation marks consistently.

10. The system of claim 7, wherein the normalized structured data sorts attributes of elements consistently.

11. A method for transmitting data comprising:
receiving structured data for transmission over a network;
identifying a template for the received structured data;
identifying template data required to file in the identified template; and
transmitting the template identifier and the template data.

12. The method of claim 11, further comprising:
receiving the template identifier and the template data;
retrieving the identified template;
entering the template data into the retrieved template; and
transmitting the structured data.

13. The method of claim 12, wherein the structured data is at least one of XML data or HTML data.

14. A method for transmitting structured data comprising:
receiving segment of structured data for transmission over a network;
calculating a semantic difference between a previously transmitted segment of structured data and a current segment of structured data; and
transmitting the semantic difference.

15. The method of claim 14, wherein the segment of structured data is a packet of structured data.

16. The method of claim 14, further comprising:
receive the transmitted semantic difference;
reconstitute the next data sequence using the previously received segment of structured data and the received semantic difference; and
transmit the reconstituted segment of structured data.

17. The method of claim 14, wherein the structured data is XML data.

18. The method of claim 16, wherein the structured data is HTML data.
